(19) United States
(12) Patent Application Publication
(10) Pub. No.: US 2013/0247339 A1
(43) Pub. Date: Sep. 26, 2013

(54) CARABINER

(71) Applicant: Franz Wurzer, Fulpmes (AT)

(72) Inventor: Franz Wurzer, Fulpmes (AT)

(21) Appl. No.: 13/990,555

(22) PCT Filed: Nov. 10, 2011
(86) PCT No.: PCT/AT2011/000450

§ 371 Date: May 30, 2013

(30) Foreign Application Priority Data
Dec. 7, 2010 (AT) A 2025/2010

(51) Int. Cl. F16B 45/02

(52) U.S. Cl. CPC F16B 45/02
USPC 24/600.1

(57) ABSTRACT

A carabiner having a bow, which has an insertion opening and first and second ends that bound the insertion opening, a closing part, which assumes a closed position in the closed state of the carabiner, in which it closes the insertion opening, first and second ends of the closing part engage with the first and second ends of the bow, and the closing part can be pivoted relative to the bow about a pivot axis formed at the engaging first ends of the bow and the closing part into a first open position in order to open the carabiner, and an actuating arm, which retains the closing part in the closed position in an initial position and is movable in order to open the carabiner. The closing part can be further pivoted relative to the bow about a pivot axis formed the engaging second ends of the bow and of the closing part into a second open position in order to open the carabiner in an alternative manner.

### BACKGROUND

The invention relates to a carabiner comprising a bow exhibiting an insertion opening, which exhibits first and second ends delimiting the insertion opening, a closing part, which adopts a closed position in the closed state of the carabiner, in which position the closing part closes the insertion opening, wherein first and second ends of the closing part engage with the first and second ends of the bow, and which can be pivoted relative to the bow into a first open position about a pivot axis configured in the region of the first ends of the bow and of the closing part engaged with one another, in order to open the carabiner, wherein the second end of the closing part moves into the area of an interior of the carabiner enclosed by the bow and the closing part in the closed state of the carabiner, and an operating arm, which keeps the closing part in its closed position in an initial position and which can be adjusted to open the carabiner.

A carabiner of this kind is disclosed in EP 1 229 258 A2. The operating arm is mounted at its first end on a portion of the bow opposite the insertion opening. Its second end is operatively connected to the closing part, for example in that it passes through an elongated opening in the closing part. When the operating arm is manipulated on the closing part, a tensile force pivoting the closing part into the opening position can be exerted via this second end.

A carabiner is disclosed in FR 2 536 805 A1, which exhibits a locking bolt to secure the closing part and prevent accidental opening. This locking bolt is pivotably mounted on a portion of the bow opposite the insertion opening. In its initial position predetermined by spring preloading, its free end lies on the inside of the closing part and prevents the closing part from pivoting inwards. After the pivoting of the locking bolt, the closing part can be pivoted inwards and the carabiner opened. Further carabiners of this kind are disclosed in FR 2 439 330 A and FR 2 485 658 A.

DE 19839853 A1 shows a carabiner comprising a member which restricts the movement space of an object, particularly a rope, suspended therein. Transverse loads on the carabiner, which could cause the carabiner to fracture, should thereby be avoided. This member restricting the movement space extends in the area between the closing part and the rear area of the bow opposite the closing part, for example it is pivotably mounted on the rear portion of the bow and its free end is adjacent to the closing part.

Carabiner hooks with pivotably mounted locking bolts on or in the closing part, which secure the carabiner in the closed state, are disclosed in WO 91/13264 and AT 400976 B, for example.

### SUMMARY

The objective to be addressed by the invention is to provide a carabiner of the kind mentioned above with an extended function. This is achieved by a carabiner having one or more features of the invention.

In the case of the carabiner in the invention, the closing part can be moved into two different open positions, wherein it is pivoted about different pivot axes. In the first open position, the closing part is pivoted about a pivot axis, which is formed by the first ends of the bow and of the closing part which are engaged with one another. The second ends of the bow and of the closing part, which are engaged in the closed position of the closing part, in which position the carabiner is closed, are disengaged in this case when the closing part is pivoted about this pivot axis. In the second open position of the closing part, the closing part is pivoted about a pivot axis, which is formed by the second ends of the bow and of the closing part which are engaged with one another. When the closing part is pivoted, starting from its closed position, into its second open position, the first ends of the bow and of the closing part which are engaged in the closed position are disengaged.

In the closed state of the carabiner, in which the closing part is in its closed position, the operating arm adopts an initial position. In this initial position, the operating arm supports the closing part to prevent pivoting, both about the pivot axis formed by the engaged first ends of the closing part and of the bow and also about the pivot axis formed by the second ends of the closing part and of the bow which are engaged with one another, and keeps both the first ends of the bow and of the closing part and also the second ends of the bow and of the closing part engaged with one another. The operating arm is adjustable starting from its mid-position in the direction of a first end position or in the direction of a second end position. This adjustment may be made by a pivoting and/or movement of the operating arm as a whole or by a bending of the operating arm. The pivoting or movement or bending takes place in this case with adjustments in the direction of the first and of the second end position in opposite directions.

During its adjustment into the first end position or into the second end position, the operating arm advantageously not only releases the closing part for pivoting about one of its two pivot axes, but exerts a force on the closing part which pivots said closing part into the first open position or the second open position. For this reason, in a possible embodiment, the second end of the operating arm is conducted via an elongated hole guide (=link block guide) opposite the closing part. The elongated hole (=slotted link opening) in this case is preferably configured in the closing part and is passed through by the operating arm in the area of its second end.

If the operating arm is adjusted into its end position, starting from its initial position, the closing part is pivoted into its open position. If the operating arm is pivoted into the second end position, starting from its initial position, the closing part is pivoted into its second open position. In the starting position of the operating arm, a pivoting of the closing part about both pivot axes is blocked and both the first ends of the bow and of the closing part and also the second ends of the bow and of the closing part are kept in mutual engagement by the operating arm and the carabiner is in its closed state.

The operating arm is adjustable from its initial position either in the direction of the first end position or in the direction of the second end position against the restoring force of at least one spring-biased member. Without the influence of external forces, the operating arm is held in its initial position by at least one spring-biased member.

The operating arm is advantageously connected to a rear portion of the bow opposite the insertion opening in the area of its first end and in the area of its second end to the closing part, wherein it divides the interior enclosed by the bow and the closing part in the closed state of the carabiner into two separate compartments. Opening in the first compartment takes place in this case by pivoting the closing part into its first end position; opening of the second compartment takes place by pivoting the closing part into its second open position. The compartments are therefore alternatively accessible by pivoting the closing part into its first open position and by pivoting the closing part into its second open position, in order to suspend a loop, for example, or for suspension in an anchored rope.

It is conceivable and possible for a locking device to be provided, through which the pivoting of the closing part about one of its pivot axes can be blocked. If an object, for example a loop, is suspended in the associated compartment of the carabiner and the pivoting of the closing part about its pivot axis is blocked using the locking device, the carabiner is secured at the suspended object, but the second compartment can still be opened by pivoting of the closing part about the other pivot axis, in order to suspend the carabiner in different objects, for example different portions of an anchored rope. Separate blocking devices could also be provided for pivoting about both pivot axes.

### BRIEF DESCRIPTION OF THE DRAWINGS

Further advantages and details of the invention are explained using the attached drawing. In the drawing:

FIG. 1 shows a view of a carabiner according to a first embodiment of the invention in the closed state;

FIG. 2 shows the carabiner from FIG. 1 in the first open position of the closed part;

FIG. 3 shows a front view of the carabiner hook in the state in FIG. 2, viewed in direction A;

FIG. 4 shows the carabiner from FIG. 1 in the second open position of the closed part;

FIG. 5 shows a schematic representation of the forces in the case of a force acting decentrally on the closed closing part;

FIG. 6 shows a representation of the ends of the bow and of the closing part during the opening of the closing part in the area of these ends;

FIG. 7 shows a representation of the ends of the bow and of the closing part when pivoting the closing part about the pivot axis formed by these engaged ends;

FIG. 8 shows a view of a carabiner in the closed state according to a second embodiment;

FIG. 9 shows a view of a carabiner in the closed state according to a third embodiment;

FIG. 10 shows a view of a carabiner in the closed state according to a fourth embodiment, and

FIG. 11 shows the carabiner from FIG. 10 in one of the open positions of the closing part.

### DETAILED DESCRIPTION OF THE PREFERRED EMBODIMENTS

Parts which are similar or have the same effect are labeled with the same reference numbers in the different embodiments.

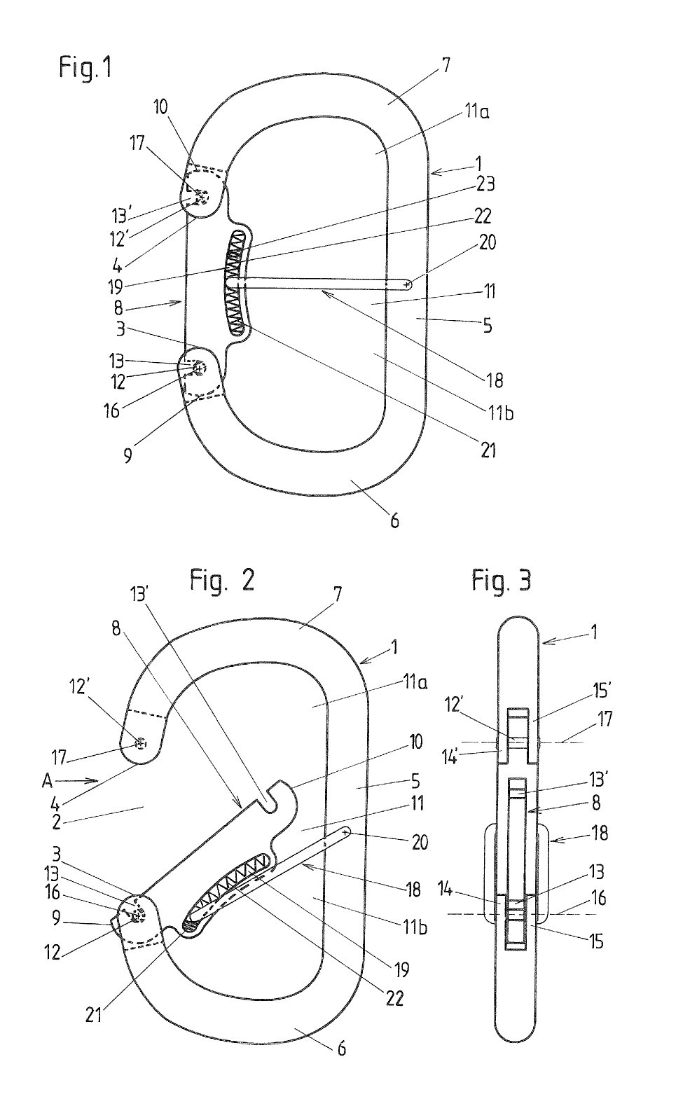

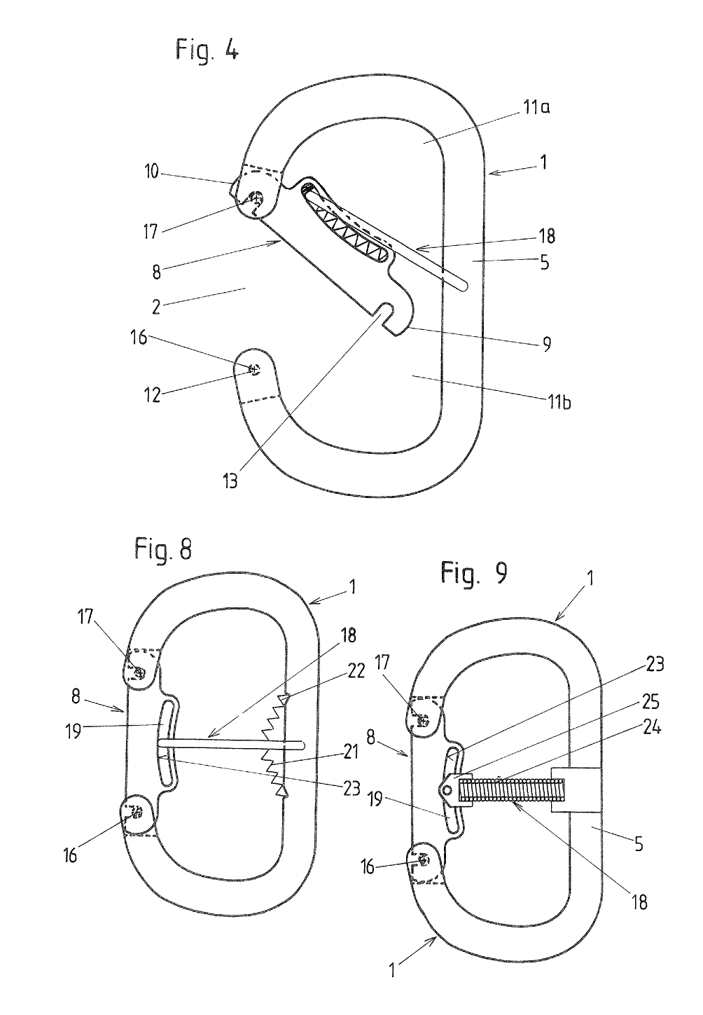

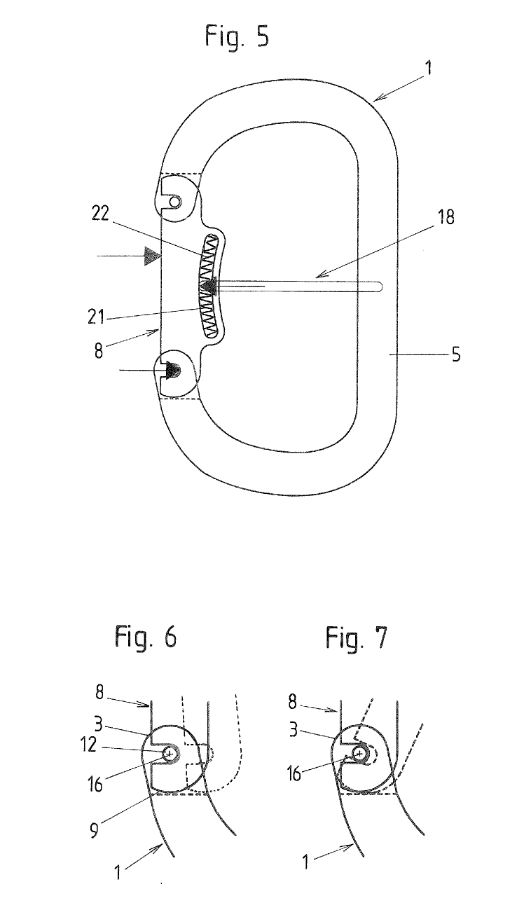

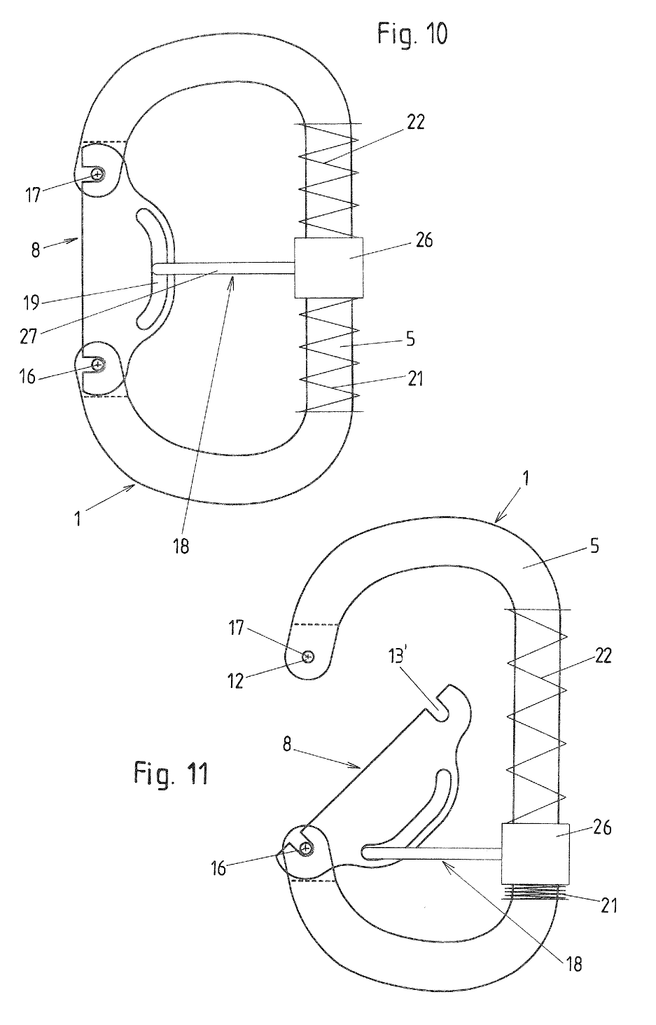

A first exemplary embodiment of a carabiner according to the invention is represented in FIGS. 1 to 7 in partially schematic form. The carabiner comprises a substantially C-shaped bow 1 exhibiting an insertion opening 2. The insertion opening 2 lies between the first and second ends 3, 4 of the bow 1. A rear portion 5 of the bow 1 lies opposite the insertion opening 2. The rear portion 5 is connected to the first end 3 of the bow 1 via a first bow portion 6 extending in a curved manner and the second end 4 of the bow 1 is connected to the rear portion 5 via a second bow portion 7 extending in a curved manner. The first and second bow portions 6, 7 in the exemplary embodiment are configured in a continuously curved manner up to an end portion adjoining the respective end. A straight-running portion could also exist, for example, in the case of one of the bow portions 6, 7 or in the case of both bow portions 6, 7 between two portions extending in a curved manner.

A closing part 8 is used to close the insertion opening 2 in a closed state of the carabiner. The closing part 8 exhibits first and second ends 9, 10 and extends in a (straight-line) longitudinal direction in the exemplary embodiment, as this is preferred. This longitudinal direction lies parallel to the rear portion 5 in this case. An angular alignment in respect of the rear portion 5 is also possible. Asymmetric carabiners of this kind are used as mountaineering carabiners, for example.

In the closed state of the carabiner, in which the closing part 8 is in its closed position, the first end 9 of the closing part 8 is engaged with the first end 3 of the bow 1 and the second end 10 of the closing part 8 is engaged with the second end 4 of the bow 1. In the closed position of the closing part 8, the bow 1 and the closing part 8 together enclose an interior 11 of the carabiner over the entire periphery of the interior 11, in other words in the manner of a closed ring.

The bow 1, the closing part 8 and the interior 11, which can also be referred to as the carabiner opening, lie on a common plane in this case (=plane or central plane of the carabiner).

The first end 9 of the closing part 8 and the first end 3 of the bow 1 are engaged when a bolt 12 fixed on the bow 1 is held in a slot 13 open to the edge of the closing part 8 facing away from the interior 11, said slot being formed in the closing part 8 in the area of the first end 9 thereof. The bolt 12 extends between two side walls 14, 15 of the bow 1, which are made available by a recess in the end portion of the bow 1. The end 9 of the closing part 8 lies between these side walls 14, 15.

In the same way, the second ends 4, 10 of the bow 1 and of the closing part 8 are in mutual engagement. The bolt 12′, which extends between the side walls 14′, 15′, is held in the slot 13′, which is formed in the area of the second end 10 of the closing part 8 and is in turn open to the edge of the closing part 8 facing away from the interior 11. The end 10 of the closing part 8 lies between the side walls 14′, 15′.

The bolt 12, 12′ could also project on both sides beyond a center bar disposed at the respective end of the bow 1 or else bolt parts of this kind could stick out on both sides from a center bar. The slots 13, 13′ at the respective end of the closing part 8 could then be disposed on side walls which overlap the center bar on both sides.

The reverse configuration, in which the bolts 12, 12′ are fixed to the closing part 8 in the end areas of the closing part 8 and the slots 13, 13′ are disposed in the end areas of the bow 1, is also conceivable and possible. In turn, side walls could also be formed in this case by a recess in the respective end 3, 4 of the bow 1 or in the respective end 9, 10 of the closing part 8, between which the end portion of the other of these two parts 1, 8 projects. If the slots 13, 13′ were disposed in the end portions of the bow 1, they would be designed open to the interior 11.

To open the carabiner 1 starting from its closed state represented in FIG. 1, the closing part 8 is pivoted either about the pivot axis 16 formed by the first ends 3, 9 of the bow 1 and of the closing part 8, which are engaged with one another, or in the pivot axis 17 formed by the two ends 4, 10 of the bow 1 and of the closing part 8, which are engaged with one another. FIG. 2 shows the maximum pivot of the closing part 8 about the pivot axis 16, in which the closing part 8 is located in its first open position. FIG. 4 shows the maximum pivot about the pivot axis 17, in which the closing part 8 is located in its second open position. When the closing part 8 is pivoted about the pivot axis 16, the second ends 4, 10 of the bow 1 and of the closing part 8 become disengaged and the second end 10 of the closing part 8 moves into the area of the interior 11. During pivoting about the pivot axis 17, the first ends 3, 9 of the bow 1 and of the closing part 8 become disengaged and the first end 9 of the closing part 8 moves into the area of the interior 11.

The pivot axes 16, 17 are at right angles to the plane in which the bow 1, the closing part 8 and the interior 11 lie (=main plane of the carabiner).

In order to keep the first ends 3, 9 of the bow 1 and of the closing part 8 and also the second ends 4, 10 of the bow 1 and of the closing part 8 in the closed position of the closing part 8 in mutual engagement, an operating arm 18 is provided. The operating arm 18 is connected to the rear portion 5 of the bow 1 via its first end and to the closing part 8 via its second end. In the initial position of the operating arm 18, in which it keeps the closing part 8 in its closed position, the second end of the operating arm 18 is connected to the closing part 8 in the area between the two pivot axes 16, 17 thereof.

In the exemplary embodiment, the operating arm 18 is pivotably mounted by its first end to the rear section 5 of the bow 1. The connection of the operating arm 18 to the closing part 8 is made in the exemplary embodiment via an elongated hole guide, which may also be referred to as a link block guide, wherein the second end of the operating arm 18 passes through an elongated hole 19 formed in the closing part 8. The elongated hole 19 exhibits an arc-shaped course, with the pivot axis 20 of the operating arm 18 as the center.

The pivot axis 20 of the operating arm 18 lies at right angles to the shared plane of the bow 1, of the closing part 8 and of the interior 11 or else parallel to the pivot axes 16, 17.

The operating arm 18 passes through the interior 11 in the area between its ends connected to the rear portion 5, on the one hand, and to the closing part 8, on the other, and divides said interior into compartments 11a, 11b. In the first open position of the closing part 8, an object to be suspended in the carabiner through the insertion opening 2 of the bow 1 can be introduced into the compartment 11a (FIG. 2), in the second open position of the closing part 8 into the compartment 11b (FIG. 4).

The operating arm 18 is represented in FIG. 1 in its initial position. In this position, the operating arm 18 is held against the restoring force of spring elements 21, 22. The spring elements 21, 22 may be formed, for example, by compression springs held in the elongated hole 19, which are supported between the edge lying at the longitudinal end of the elongated hole 19 in each case and the operating arm 18.

In the first open position of the closing part 8 illustrated in FIG. 2, the operating arm 18 is located in its first end position; in the second open position of the closing part 8 represented in FIG. 4, the operating arm 18 is in its second end position. In the exemplary embodiment, in which the operating arm 18 is pivotably mounted about the pivot axis 20, the operating arm 18 is adjusted from its initial position into one of its end positions by pivoting about the pivot axis 20. In this case, the pivoting direction during pivoting into the first end position is opposite to the pivoting direction during adjustment into the second end position.

In the exemplary embodiment of a symmetrical carabiner shown, the initial position of the operating arm 18 preferably lies in the middle between the two end positions.

In order to lock the closing part 8 in its closed position, the operating arm 18 interacts with a support surface 23 of the operating arm 18 facing the interior 11. In the exemplary embodiment, this support surface is formed by the edge of the elongated hole 19. At this support surface 23, the closing part 8 is supported on the operating arm 18 to prevent pivoting about one of its pivot axes 16, 17 and to prevent movement in the direction of the rear portion 5. The surface normal on the support surface 23 faces the point at which a compressive force acting on the operating arm 18 is deflected onto the bow 1, in other words onto the pivot axis 20 of the operating arm 18 in this exemplary embodiment.

If the operating arm 18 is adjusted starting from its mid-position in the direction of one of the two end positions, the locking of the closing part 8 in its closed position continues to exist in a first segment of the adjustment path, which is advantageously at least 30% of the total adjustment path in the respective adjustment direction.

If the operating arm 18 reaches the end of the adjustment path in the elongated hole guide formed by the elongated hole 19 during adjustment in the direction of one of its settings, then during further adjustment of the operating arm 18 in the direction of its end position in each case, the closing part 8 is pivoted about the respective pivot axis 16, 17 by the operating arm 18, in other words, during adjustment of the operating arm 18 in the direction of its first end position, about the pivot axis 16 formed by the engaged first ends 3, 9 of the bow 1 and of the closing part 8, and during adjustment of the operating arm 18 in the direction of its second end position, about the pivot axis 17 formed by the engaged second ends 4, 10 of the bow 1 and of the closing part 8. In the exemplary embodiment shown, the end of the adjustment path is reached in the elongated hole 19 when the respective spring element 21, 22 formed by a compression spring reaches the limit stop. At the end of the adjustment path, the second end of the operating arm 18 engaged with the closing part 8 in this embodiment has pivoted at least until it is proximate to the connecting line between the respective pivot axis 16, 17 of the closing part 8 and the pivot axis 20 of the operating arm 18 (“proximate” in this context means that at least 90% of the pivot angle has been covered by the time this connecting line is reached). When the operating arm 18 is further adjusted in the direction of its end position in each case, the pivoting of the closing part 8 in the direction of its open position in each case takes place as a result of the tensile force exerted by the operating arm 18 on the closing part 8.

If the operating arm 18 is thereby moved by the user, starting from its initial position into one of its end positions, the closing part 8 is pivoted by the operating arm 18 into one of its two open positions, as a result of which the carabiner is opened towards one of the two compartments 11a, 11b.

FIG. 5 illustrates the forces which arise when, in the closed state of the carabiner, a force acts on the closing part 8 in an area lying laterally next to the support of the operating arm 18 on the supporting surface 23 of the closing part 8, which acts in the manner of a pressing of the closing part 8 into the interior 11. The counterforces are applied by the support of the operating arm 18 on the support surface 23 and by the engagement of the opposite end 9 of the closing part 8 in the end 3 of the bow 1 interacting therewith.

FIG. 6 depicts how the end of the closing part 8 opposite the active pivot axis 16, 17 in each case, the first end 9 in this case, can be disengaged from the corresponding end 3 of the bow 1 when pivoting begins. So that the first ends 3, 9 and the second ends 4, 10 are disengaged, the bolt 12, 12′ travels out of the slot 13, 13′ in which it is held to form the pivot axis 16, 17 in each case.

FIG. 7 shows that as soon as a particular angle of the pivoting of the closing part 8 about one of the pivot axes is reached, for example as illustrated the pivot axis 16, the corresponding end 9 of the closing part 8, by which this pivot angle 16 is formed in conjunction with the associated end 3 of the bow 1, can no longer be disengaged from the associated end 3 of the bow 1. This angle advantageously lies within the range of 5° to 25°.

Through the division of the interior 11 into two compartments 11a, 11b, a transverse positioning of the carabiner between two objects suspended in the carabiner, between which a tensile force is transmitted via the carabiner, can be prevented. The forces which can be transferred by the carabiner in a transverse direction are normally smaller than the forces which can be transferred in a longitudinal direction (if the suspended objects are located in the area of the bow portions 6 and 7).

A slightly modified embodiment is represented in FIG. 8. In this case, the spring elements 21, 22 are not disposed within the elongated hole 19, but are each connected at their one end to the rear portion 5 and at their other end to the operating arm 18 spaced apart from the pivot axis 20. The end of the adjustment path of the operating arm 18 in the elongated hole 19 is achieved in this case in each of the two adjustment directions, when the operating arm 18 runs up to the respective end of the elongated hole 19. When the operating arm 18 is further adjusted in this adjustment direction, the closing part 8 is pivoted by the operating arm 18 in the direction of the open position of the closing part 8 in each case. Otherwise, this exemplary embodiment corresponds to the exemplary embodiment described previously.

The exemplary embodiment represented in FIG. 9 corresponds to the previously described exemplary embodiments, apart from the following differences:

The operating arm 18 in this case is configured in a spring-biased bendable manner. This is achieved in the exemplary embodiment shown by a block-wound compression spring 24. This spring-biased configuration of the operating arm 18 forms the spring-biased member, which exerts a restoring force against an adjustment of the operating arm from its initial position. The adjustment of the operating arm 18 in the direction of one of its two end positions is achieved in this case by bending the operating arm 18 in the corresponding direction (within the main plane of the carabiner). The end position of the movability of the operating arm 18 in the elongated hole 19 in one of the adjustment directions of the operating arm 18 is reached when the operating arm 18 runs up to the respective end of the elongated hole 19. Consequently, the operating arm 18 pivots the closing part 8 during its further adjustment in the direction of one of its end positions about the corresponding pivot axis 16, 17.

In the closed position of the closing part 8, the operating arm 18 in turn supports the closing part 8 against pressing (moving and/or pivoting) inwards.

The operating arm 18 in this exemplary embodiment comprises the compression spring 24 and the head 25 attached to the compression spring 24, which exhibits a pin passing through the elongated hole 19.

Elastically bendable operating arms 18, which can support the closing part 8 in the closed position thereof against inward deflection, could also be configured in another way.

A further exemplary embodiment of the invention is illustrated in FIGS. 10 and 11. In this exemplary embodiment, the operating arm 18 is not pivotably, but movably, mounted on the rear portion 5 of the bow 1. For this purpose, as represented, for example, the operating arm 18 exhibits a sleeve movably disposed on the rear portion 5. The arm part 27 is attached to the sleeve 26. The end of the arm part 27 remote from the rear portion 5 is connected to the closing part 8 via an elongated hole guide, for example, as depicted. In the exemplary embodiment shown, the elongated hole 19 is arranged in the closing part 8 and the arm part 27 engages with this elongated hole 19.

The operating arm 18 is held in the initial position by spring elements 21, 22. The operating arm 18 in turn keeps the first and second ends 9, 10 of the closing part 8 in engagement with the first and second ends 3, 4 of the bow 1 in this position, when the support surface 23 of the closing part 8 is supported at the end of the operating arm 18 remote from the rear portion 5. The spring elements 21, 22 are formed by compression springs disposed on the rear section 5, for example. Embodiments would also be possible, for example, in which the spring elements 21, 22 are disposed within the rear portion.

In the initial position of the operating arm 18, the end of the operating arm 18 remote from the rear portion 5 is located in a middle section of the elongated hole 19, in which said elongated hole runs parallel to the rear section 5. End portions, in which the elongated hole is remote from the rear portion 5 towards the respective end, are attached to the middle portion of the elongated hole 19 on both sides. If the operating arm 18 is moved from its initial position into one of its two end positions, the end of the operating arm 18 remote from the rear portion 5 arrives in the corresponding end portion of the elongated hole, once it has passed through the middle portion of the elongated hole 19, wherein it pivots the closing part 8 about the corresponding pivot axis. The pivoting about the pivot axis formed by the engaged first ends 3, 9 of the bow 1 and of the closing part 8 is illustrated in FIG. 11. When the operating arm 18 is adjusted into the other end position, the closing part 8 pivots about the pivot axis 17 formed by the engaged second ends 4, 10 of the bow 1 and of the closing part 8.

As soon as the end of the operating arm 18 remote from the rear portion 5 is located in the middle portion of the elongated hole 19, the closing part 8 is locked to prevent opening.

Otherwise, this exemplary embodiment corresponds to the previously described exemplary embodiments.

In all exemplary embodiments described, the following modifications are possible, for example, without falling outside the field of the invention:

A locking device (securing device) for the operating arm 18 could be provided, by which the operating arm 18 is locked in its initial position in a locked position. Only by adjusting the locking device into its release position is an adjustment of the operating arm 18 in the direction of one of its end positions made possible. Locking devices of this kind interacting with the operating arm 18 can be realized in different ways, for example by locking levers, safety catches or the like, which block the pivoting or movement of the operating arm 18. Each of the two operating directions of the operating arm 18 could be provided with its own locking member in this case or with a locking member acting in both operating directions.

The end of the operating arm 18 remote from the rear portion 5 could also be connected to the closing part 8 via a part movably mounted on or in the closing part 8. This movably mounted part could be movably mounted on a (partially or completely) curved track, so that the end of the operating arm 18 remote from the rear portion 5 is guided on a corresponding track, which may correspond, for example, to the track represented in the respective exemplary embodiment in the figures. The end of the operating arm 18 remote from the rear portion 5 could be pivotably connected to this movably conducted part.

An elongated hole guide could also be configured in this way, such that at the end of the operating arm 18 remote from the rear portion 5, an arm part is present with an enlarged extension in the direction of the closing part 8, which exhibits an elongated hole, with which a pin connected to the closing part 8 engages. In the case of the exemplary embodiments depicted in FIGS. 1 to 9, the elongated hole could exhibit the same shape as the elongated hole 19 of the closing part 8 depicted. In the case of the exemplary embodiment in FIGS. 10 and 11, the end portions of this elongated hole attached to the middle portion lying parallel to the rear portion 5 could draw near to the rear portion 5.

The invention is not limited to a symmetrical configuration of the bow 1 in accordance with the exemplary embodiments, but can likewise be used with asymmetric carabiners. In this case, the rear portion 5 is aligned at an angle to the longitudinal extension of the closing part 8. Asymmetrical carabiners of this kind, which are used for mountaineering, for example, emerge from the state of the art mentioned above in accordance with EP 1 229 258 A2, for example.

The first ends 3, 4 and the second ends 5, 10 of the bow 1 and of the closing part 8 engaged with one another could also exhibit another form for the configuration of pivot axes 16, 17, for example a joint head could be disposed at one end in each case, said joint head engaging with a joint socket in the other of the two ends.

The elongated hole 19 in all embodiments described could also be open to the interior 11 in a middle portion, i.e. the closing part 8 exhibits a recess which extends in the middle section of the elongated hole 19 between the elongated hole 19 and the interior 11. A bolt device could be provided for the operating arm 18 in the area of this recess. In the closed state of the bolt device, said device blocks an adjustment of the end of the operating arm 18 remote from the rear portion 5 against an adjustment in the elongated hole 19 and keeps the operating arm 18 secure in its initial position. In the release position, the bolt device releases the operating arm 18 for adjustment.

### KEY TO THE REFERENCE NUMBERS

1 Bow

2 Insertion opening

3 First end

4 Second end

5 Rear portion

6 First bow portion

7 Second bow portion

8 Closing part

9 First end

10 Second end

11 Interior

11a Compartment

11b Compartment

12, 12′ Bolt

13, 13′ Slot

14, 14′ Side wall

15, 15′ Side wall

16 Pivot axis

17 Pivot axis

18 Operating arm

19 Elongated hole

20 Pivot axis

21 Spring element

22 Spring element

23 Support surface

24 Compression spring

25 Head

26 Sleeve

27 Arm part

1. A carabiner comprising a bow having an insertion opening, and having first and second ends delimiting the insertion opening, a closing part, which adopts a closed position in a closed state of the carabiner, in which position the closing part closes the insertion opening, wherein first and second ends of the closing part engage with the first and second ends of the bow, and the closing part can be pivoted relative to the bow into a first open position about a first pivot axis configured in a region of the first ends of the bow and of the closing part engaged with one another, in order to open the carabiner, wherein the second end of the closing part moves into an area of an interior of the carabiner enclosed by the bow and the closing part in the closed state of the carabiner, and an operating arm, which keeps the closing part in the closed position in an initial position of the operating arm and which can be adjusted to open the carabiner, and for an alternative opening of the carabiner, the closing part can be pivoted relative to the bow about a second pivot axis formed in an area of the second ends of the bow and of the closing part which are engaged with one another into a second open position, wherein the first end of the closing part moves into the area of the interior of the carabiner enclosed by the bow and the closing part in the closed state.

2. The carabiner as claimed in claim 1, wherein the operating arm passes through the interior enclosed by the bow and the closing part in the closed state of the carabiner.

3. The carabiner as claimed in claim 1, wherein the operating arm is connected to a rear portion of the bow opposite the insertion opening in an area of a first end thereof and in an area of a second end thereof to the closing part.

4. The carabiner as claimed in claim 3, wherein the operating arm is connected to the closing part in the area of the second end thereof via an elongated hole guide.

5. The carabiner as claimed in claim 4, wherein the closing part includes an elongated hole, with which the second end of the operating arm engages.

6. The carabiner as claimed in claim 1, wherein without influence of external forces, the operating arm adopts the initial position, in which it keeps the closing part in the closed position and from which it is adjustable against a restoring force of at least one spring-biased member in a direction of a first end position, in which the closing part adopts the first open position, and in a direction of a second end position, in which the closing part adopts the second end position.

7. The carabiner as claimed in claim 1, wherein the operating arm is at least one of pivotably/or movably mounted on the bow.

8. The carabiner as claimed in claim 1, wherein pivoting of the closing part takes place about one of the pivot axes for opening the carabiner by a force exerted by the operating arm during adjustment on the closing part.

9. The carabiner as claimed in claim 1, wherein the pivot axes of the first and second ends of the bow and of the closing part which are engaged with one another are each formed by a bolt secured to one of the two parts, which engages in a slot formed in the other of the two parts.
